(19) United States
(12) Patent Application Publication
(10) Pub. No.: US 2025/0391276 A1
(43) Pub. Date: Dec. 25, 2025

(54) NAVIGATION ASSISTANCE DEVICE, NAVIGATION ASSISTANCE METHOD, AND RECORDING MEDIUM

(71) Applicant: Furuno Electric Co., Ltd., Nishinomiya (JP)

(72) Inventors: Makoto YOSHINAGA, Nishinomiya (JP); Kazuya NAKAGAWA, Amagasaki (JP); Daisuke MATSUMOTO, Kobe (JP)

(21) Appl. No.: 19/310,033

(22) Filed: Aug. 26, 2025

Related U.S. Application Data
(63) Continuation of application No. PCT/JP2023/045678, filed on Dec. 20, 2023.

(30) Foreign Application Priority Data
Feb. 28, 2023 (JP) 2023- 029482

(51) Int. Cl. G08G 3/02

(52) U.S. Cl. CPC G08G 3/02

(57) ABSTRACT

A navigation assistance device is provided, including processing circuitry configured to acquire first ship data representing the position and speed of a first ship; acquire second ship data representing the position and speed of a second ship; on the basis of the first ship data and the second ship data, calculate a first collision risk value based on the time required for the second ship to approach the first ship; on the basis of the first ship data and the second ship data, calculate a second collision risk value based on the distance between the first ship and the second ship; and on the basis of the first collision risk value and the second collision risk value, determine whether there is a risk of collision between the first ship and the second ship.

### CROSS-REFERENCE TO RELATED APPLICATION

The present application is a continuation of PCT/JP2023/045678, filed on Dec. 20, 2023, and is related to and claims priority from Japanese patent application no. 2023-029482, filed on Feb. 28, 2023. The entire contents of the aforementioned application are hereby incorporated by reference herein.

### TECHNICAL FIELD

The disclosure relates to a navigation assistance device, a navigation assistance method, and a recording medium.

### BACKGROUND

Patent Literature 1 (Japanese Patent Application Laid-Open No. H11-272999) discloses a technology that determines the future collision risk level between the own ship and another ship when the own ship navigates based on a sailing schedule, and further, sequentially calculates a collision risk level that considers temporal certainty by weighting with the time until the future state is reached for the determined collision risk level.

Conventionally, CPA (Closest Point of Approach) collision alarm is known. In the CPA collision alarm, the issuance of an alarm is judged based on the time until the other ship makes the closest approach to the own ship.

However, generally, the timing to start paying attention to the other ship with a high collision risk varies depending on the navigators, with some using the time of approach of the other ship as a criterion, some using the distance between the own ship and the other ship as a criterion, or some using both time and distance as criteria.

Therefore, collision alarms based on the time until the other ship approaches the own ship, such as the CPA collision alarm, may not match the sense of navigators who use the distance between the own ship and the other ship as a criterion.

At least one embodiment of the disclosure relates to a navigation assistance device, a navigation assistance method, and a recording medium that make it possible to combine assessment criteria for a collision risk.

### SUMMARY

A navigation assistance device according to one aspect of the disclosure includes processing circuitry configured to: acquire first ship data representing a position and a speed of a first ship; acquire second ship data representing a position and a speed of a second ship; calculate a first collision risk value based on a time when the second ship approaches the first ship, based on the first ship data and the second ship data; calculate a second collision risk value based on a distance between the first ship and the second ship, based on the first ship data and the second ship data; and determine whether a collision risk exists between the first ship and the second ship based on the first collision risk value and the second collision risk value. Accordingly, it becomes possible to combine assessment criteria for a collision risk.

In the above aspect, the processing circuitry may be further configured to adjust one or both of a weight of a reference time when the first collision risk value changes from a value representing no collision risk to a value representing that a collision risk exists, and a weight of a reference distance at which the second collision risk value changes from a value representing no collision risk to a value representing that a collision risk exists. Accordingly, it becomes possible to improve the flexibility of the assessment criteria.

In the above aspect, the processing circuitry may be further configured to link the weight of the reference time and the weight of the reference distance. Accordingly, it becomes possible to facilitate the setting of weights.

In the above aspect, the processing circuitry may be further configured to decrease one of the weight of the reference time and the weight of the reference distance when increasing the other. Accordingly, it becomes possible to make one of the assessment criteria stand out.

In the above aspect, the processing circuitry may be further configured to display an image showing a first range where the first collision risk value becomes a value representing that a collision risk exists, and a second range where the second collision risk value becomes a value representing that a collision risk exists, based on the first ship. Accordingly, it becomes easier to visually grasp the combined assessment criteria.

In the above aspect, the processing circuitry may be further configured to receive operation input in a first direction from a user and operation input in a second direction opposite to the first direction, and increase the weight of the reference time in response to operation input in the first direction, and increase the weight of the reference distance in response to operation input in the second direction. Accordingly, it becomes possible to facilitate the setting of weights.

In the above aspect, the processing circuitry may be further configured to display a graph having a first axis corresponding to the weight of the reference time and a second axis corresponding to the weight of the reference distance; and receive operation input from a user specifying a position within the graph, and the processing circuitry may be further configured to adjust one or both of the weight of the reference time and the weight of the reference distance according to the position within the graph specified by the user. Accordingly, it becomes possible to facilitate the setting of weights.

In the above aspect, the processing circuitry may be further configured to display an image representing a positional relationship between the first ship and the second ship based on the first ship data and the second ship data, and the processing circuitry may be further configured to display with distinction, in the image, a symbol representing the second ship determined to have a collision risk based on the first collision risk value and a symbol representing the second ship determined to have a collision risk based on the second collision risk value. Accordingly, it becomes easier to visually grasp which of the assessment criteria indicates a collision risk.

In the above aspect, the processing circuitry may be further configured to determine to issue an alarm according to whether a collision risk exists. Accordingly, it becomes possible to issue an alarm based on the combined assessment criteria.

Furthermore, a navigation assistance method according to another aspect of the disclosure includes acquiring first ship data representing a position and a speed of a first ship; acquiring second ship data representing a position and a speed of a second ship; calculating a first collision risk value based on a time when the second ship approaches the first ship, based on the first ship data and the second ship data; calculating a second collision risk value based on a distance between the first ship and the second ship, based on the first ship data and the second ship data; and determining whether a collision risk exists between the first ship and the second ship based on the first collision risk value and the second collision risk value. Accordingly, it becomes possible to combine assessment criteria for a collision risk.

Furthermore, a non-transient computer-readable recording medium according to another aspect of the disclosure records a program that causes a computer to execute acquiring first ship data representing a position and a speed of a first ship; acquiring second ship data representing a position and a speed of a second ship; calculating a first collision risk value based on a time when the second ship approaches the first ship, based on the first ship data and the second ship data; calculating a second collision risk value based on a distance between the first ship and the second ship, based on the first ship data and the second ship data; and determining whether a collision risk exists between the first ship and the second ship based on the first collision risk value and the second collision risk value. Accordingly, it becomes possible to combine assessment criteria for a collision risk.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a diagram showing an example of the onboard system.

FIG. 2 is a diagram showing an example of the navigation assistance device.

FIG. 3 is a diagram showing an example of the other ship management database.

FIG. 4 is a diagram for illustrating CPA.

FIG. 5 is a diagram for illustrating BCT.

FIG. 6 is a diagram showing an example of the collision risk value.

FIG. 7 is a diagram for illustrating the constant distance.

FIG. 8 is a diagram for illustrating the bumper.

FIG. 9 is a diagram for illustrating an example of weight adjustment.

FIG. 10 is a diagram for illustrating an example of the alarm line.

FIG. 11 is a diagram for illustrating an example of the alarm line.

FIG. 12 is a diagram for illustrating an example of the alarm line.

FIG. 13 is a diagram for illustrating an example of weight adjustment.

FIG. 14 is a diagram for illustrating an example of the alarm line.

FIG. 15 is a diagram for illustrating an example of the alarm line.

FIG. 16 is a diagram showing a display example.

FIG. 17 is a diagram showing a display example.

FIG. 18 is a diagram showing a display example.

FIG. 19 is a diagram showing an example of the navigation assistance method.

### DETAILED DESCRIPTION

The following describes embodiments of the disclosure with reference to the figures.

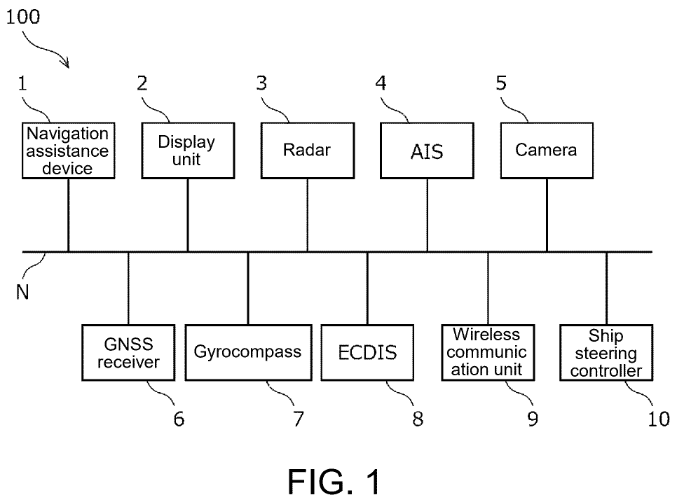

FIG. 1 is a block diagram showing a configuration example of an onboard system 100. The onboard system 100 is a system mounted on a ship. In the following description, the ship on which the onboard system 100 is mounted is referred to as “own ship,” and another ship is referred to as “other ship.”

The onboard system 100 includes a navigation assistance device 1, a display unit 2, a radar 3, an AIS 4, a camera 5, a GNSS receiver 6, a gyrocompass 7, an ECDIS 8, a wireless communication unit 9, and a ship steering controller 10. These devices are connected to a network N such as LAN, enabling network communication with each other.

The navigation assistance device 1 includes a computer that includes a CPU, a RAM, a ROM, a non-volatile memory, an input/output interface, etc. The CPU of the navigation assistance device 1 executes information processing according to a program loaded from the ROM or the non-volatile memory to the RAM.

The program may be supplied via an information storage medium such as an optical disk or a memory card, or may be supplied via a communication network such as the Internet or LAN.

The display unit 2 displays a display image generated by the navigation assistance device 1. The display unit 2 also displays a radar image, a camera image, or an electronic chart.

The display unit 2 is, for example, a display device with a touch sensor, commonly known as a touch panel. The touch sensor detects an indicated position on the screen by a finger of a user or the like. Alternatively, an indicated position may be input by a pointing device such as a trackball.

The radar 3 emits radio waves around the own ship and receives reflected waves, and generates echo data based on received signals. Additionally, the radar 3 identifies a target object from the echo data and generates TT data (Target Tracking Data) that represents the position and speed of the target object.

The AIS (Automatic Identification System) 4 receives AIS data from another ship existing around the own ship or from land-based control. The disclosure is not limited to an AIS, and a VDES (VHF Data Exchange System) may be used. The AIS data includes the identification code, ship name, position, course, ship speed, ship type, hull length, and destination of the other ship.

The camera 5 is a digital camera that captures the external view from the own ship and generates image data. The camera 5 is installed, for example, on a bridge of the own ship facing a heading direction. The camera 5 is, for example, a so-called PTZ camera having a pan-tilt function and an optical zoom function.

The camera 5 may include an image recognition unit that estimates the position in the image and the type of the target object such as a ship included in the captured image by an object detection model. The image recognition unit may be implemented in other devices such as the navigation assistance device 1, and is not necessarily in the camera 5.

The GNSS receiver 6 detects the position of the own ship based on radio waves received from GNSS (Global Navigation Satellite System). The gyrocompass 7 detects the heading direction of the own ship. The disclosure is not limited to a gyrocompass, and a GPS compass may be used.

The ECDIS (Electronic Chart Display and Information System) 8 obtains the position of the own ship from the GNSS receiver 6 and displays the position of the own ship on an electronic chart. The ECDIS 8 also displays a planned route of the own ship on the electronic chart. The disclosure is not limited to an ECDIS, and a GNSS plotter may be used.

The wireless communication unit 9 includes wireless equipment that enables satellite communication. Additionally, the wireless communication unit 9 includes wireless equipment that enables wireless communication utilizing, for example, ultra-high frequency waves, very high frequency waves, high frequency waves, medium high frequency waves, or medium frequency waves.

The ship steering controller 10 is a control device for realizing autonomous navigation and controls a steering gear of the own ship. Additionally, the ship steering controller 10 may control an engine of the own ship.

In this embodiment, the navigation assistance device 1 and the display unit 2 are devices independent of each other, but the disclosure is not limited thereto, and the navigation assistance device 1 and the display unit 2 may be an integrated device.

Further, the navigation assistance device 1 is an independent device, but not limited thereto, and may also be integrated with other devices such as the ECDIS 8. That is, the functional unit of the navigation assistance device 1 may be implemented in other devices.

Additionally, the display unit 2 is also an independent device, but not limited thereto, and a display unit of other devices such as the ECDIS 8 may be used as the display unit 2 that displays the display image generated by the navigation assistance device 1.

It should be noted that, in this embodiment, the navigation assistance device 1 is mounted on a ship, but not limited thereto, and the navigation assistance device 1 may be installed, for example, in a land-based control to determine a collision risk between ships.

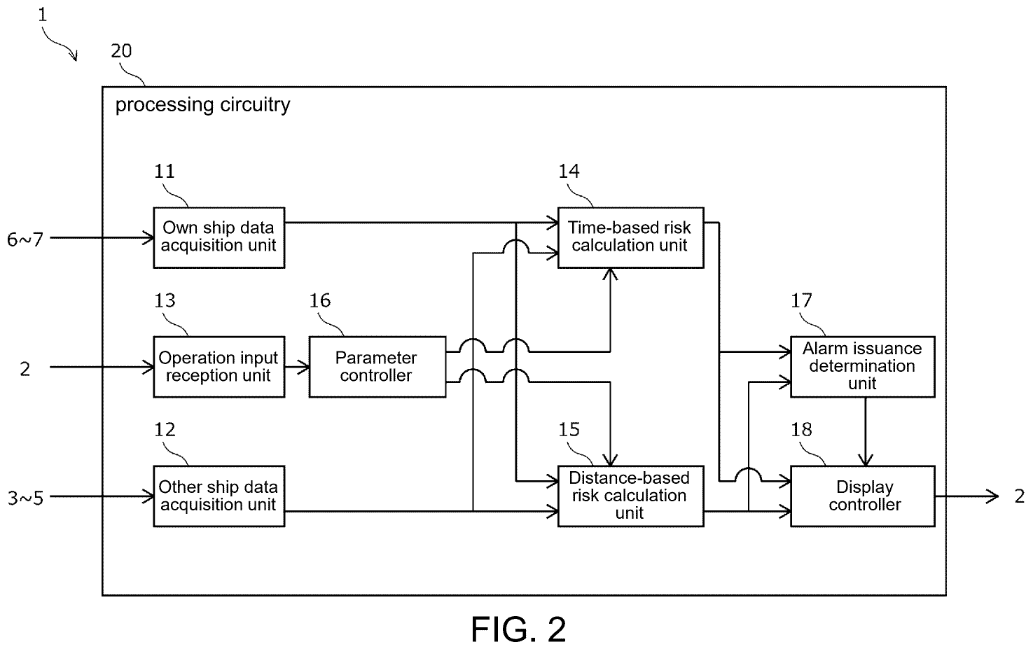

FIG. 2 is a block diagram showing a configuration example of the navigation assistance device 1. The navigation assistance device 1 includes processing circuitry 20. The processing circuitry 20 is a computer including a CPU, a RAM, a ROM, a non-volatile memory, an input/output interface, etc.

The processing circuitry 20 includes an own ship data acquisition unit 11, another ship data acquisition unit 12, an operation input reception unit 13, a time-based risk calculation unit 14, a distance-based risk calculation unit 15, a parameter controller 16, an alarm issuance determination unit 17, and a display controller 18. These functional units are implemented by the CPU of the processing circuitry 20 through execution of information processing according to a program.

The own ship data acquisition unit 11 is an example of a first acquisition unit, and the other ship data acquisition unit 12 is an example of a second acquisition unit. The time-based risk calculation unit 14 is an example of a first calculation unit, and the distance-based risk calculation unit 15 is an example of a second calculation unit. The parameter controller 16 is an example of a controller, and the alarm issuance determination unit 17 is an example of a determination unit.

The own ship data acquisition unit 11 acquires own ship data representing the position and speed of the own ship. The own ship is an example of a first ship, and the own ship data is an example of first ship data. The speed is a vector quantity represented by a ship speed and a course, and the ship speed is a scalar quantity.

Specifically, the own ship data acquisition unit 11 sequentially acquires the position of the own ship detected by the GNSS receiver 6 and calculates the speed of the own ship from a temporal change of the position of the own ship. The disclosure is not limited thereto, and the ship speed of the own ship may be acquired from a speed log (not shown), and the course of the own ship may be acquired from the gyrocompass 7.

The other ship data acquisition unit 12 acquires other ship data representing the position and speed of the other ship. The other ship is an example of a second ship, and the other ship data is an example of second ship data. The other ship data is generated based on data detected by the radar 3, the AIS 4, or the camera 5 mounted on the own ship.

Specifically, the other ship data acquisition unit 12 sequentially acquires TT data generated by the radar 3, AIS data received by the AIS 4, or identification data identified from the image captured by the camera 5, as the other ship data. The other ship data acquisition unit 12 registers the acquired other ship data in another ship management database constructed in a memory.

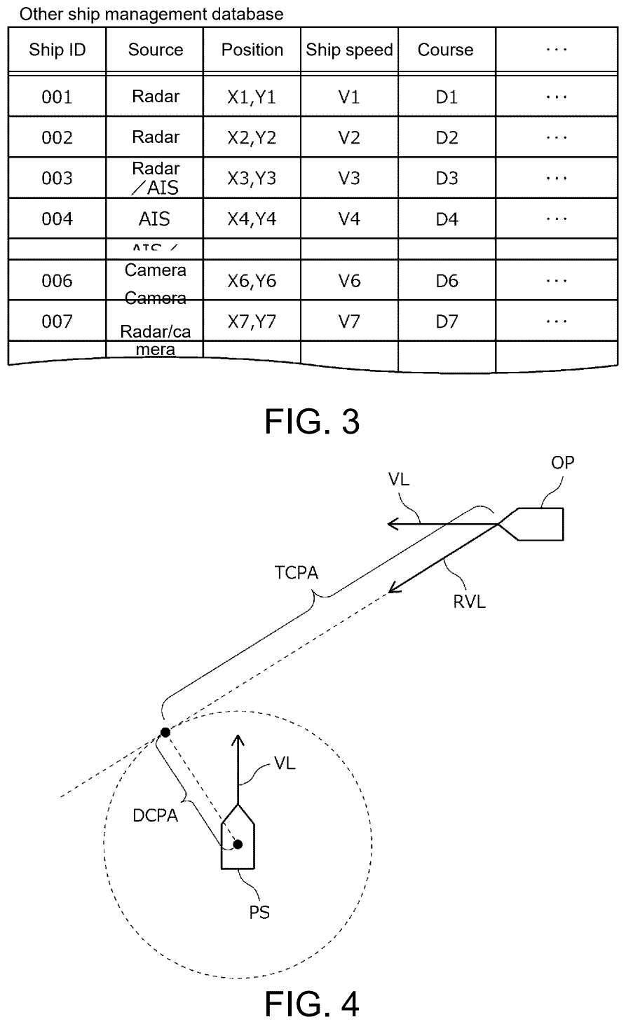

As shown in FIG. 3, the other ship management database includes fields such as “Ship ID,” “Source,” “Position,” “Ship speed,” and “Course.” “Ship ID” is an identifier assigned to the other ship. “Source” indicates whether the other ship data was generated by any of the radar 3, the AIS 4, and the camera 5.

“Position” represents the position of the other ship. The position of the other ship is represented in latitude and longitude. Since the position of the other ship detected by the radar 3 or the camera 5 is represented as a relative position to the own ship, the position of the other ship is converted into an absolute position using the position of the own ship detected by the GNSS receiver 6.

“Ship speed” represents the ship speed of the other ship. “Course” represents the course of the other ship. The ship speed and course of the other ship detected by the radar 3 or the camera 5 are estimated from a temporal change of the position in the image of the other ship.

It should be noted that in a case where the position of the other ship data sourced from one of the radar 3, the AIS 4, and the camera 5 is identical or similar to the position of the other ship data sourced from another one, those other ship data records are consolidated as relating to the same other ship.

Returning to the illustration of FIG. 2, the operation input reception unit 13 receives operation input from the user. Specifically, the operation input reception unit 13 receives operation input of the user specifying a position on the screen from the display unit 2 which is a touch panel.

Further, the operation input reception unit 13 may receive operation input of the user from operation members such as a button 21 or a rotary knob 22 (see FIG. 17) provided on the navigation assistance device 1 or the display unit 2.

The time-based risk calculation unit 14 calculates a time-based collision risk value based on the time when the other ship approaches the own ship, based on the own ship data acquired by the own ship data acquisition unit 11 and the other ship data acquired by the other ship data acquisition unit 12. The time-based collision risk value is an example of a first collision risk valuc.

The time-based collision risk value is a collision risk value that changes according to a time indicator representing the time until the other ship approaches the own ship. The time indicator is, for example, TCPA (Time to Closest Point of Approach) in CPA collision alarm, or BCT (Bow Crossing Time), etc.

As shown in FIG. 4, TCPA is the time until the other ship OP comes closest to the own ship PS. DCPA is the distance when the other ship OP comes closest to the own ship PS. TCPA and DCPA are calculated based on the relative velocity vector RVL of the velocity vector VL of the own ship PS and the velocity vector VL of the other ship OP.

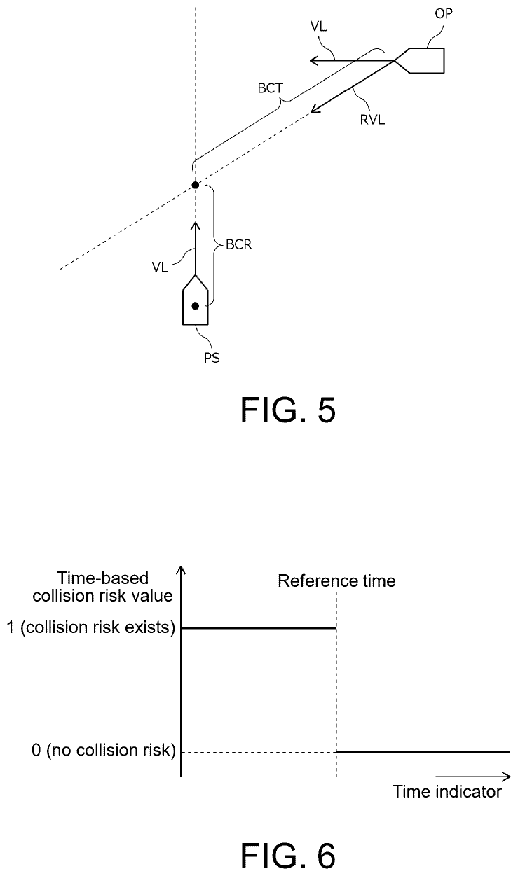

As shown in FIG. 5, BCT is the time until the other ship OP crosses the bow line of the own ship PS. BCR is the distance to the position where the other ship OP crosses the bow line of the own ship PS. BCT and BCR are also calculated based on the relative velocity vector RVL of the velocity vector VL of the own ship PS and the velocity vector VL of the other ship OP.

The time-based collision risk value is determined according to the relationship between the time indicator such as TCPA or BCT and a particular reference time. The reference time is the time when the time-based collision risk value changes from a value representing no collision risk (for example, 0) to a value representing that a collision risk exists (for example, 1). The reference time is also called a threshold value.

As shown in FIG. 6, the time-based collision risk value is represented by a step function that is 0 when the time indicator such as TCPA or BCT is larger than the reference time, and changes to 1 when the time indicator becomes equal to or less than the reference time.

The disclosure is not limited thereto, and the time-based collision risk value may change gradually in the vicinity of the reference time, and may be represented by a non-linear function such as a sigmoid function.

The distance-based risk calculation unit 15 calculates a distance-based collision risk value based on the distance between the own ship and the other ship, based on the own ship data acquired by the own ship data acquisition unit 11 and the other ship data acquired by the other ship data acquisition unit 12. The distance-based collision risk value is an example of a second collision risk value.

The distance-based collision risk value is a collision risk value that changes according to a distance indicator representing the distance between the own ship and the other ship. The distance indicator is, for example, the actual distance between the own ship and the other ship.

The distance-based collision risk value is determined according to the relationship between the distance indicator and a particular reference distance, similar to the time-based collision risk value described above. The reference distance is a distance at which the distance-based collision risk value changes from a value representing no collision risk (for example, 0) to a value representing that a collision risk exists (for example, 1). The reference distance is also called a threshold value.

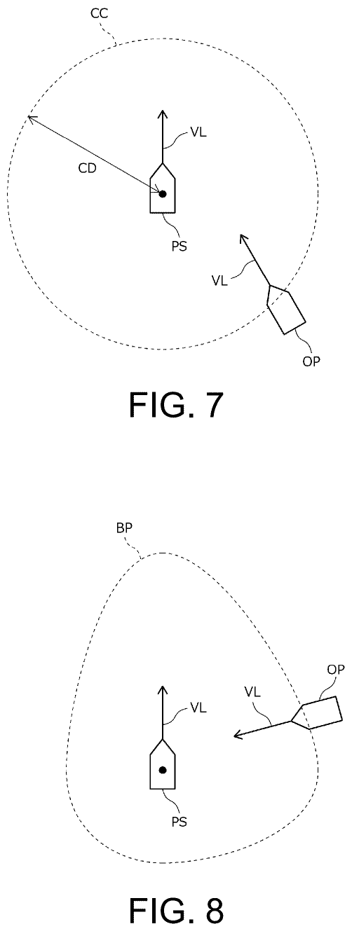

In the example shown in FIG. 7, the distance-based collision risk value is 0 when the distance between the own ship PS and the other ship OP is larger than the reference distance CD, and changes to 1 when the distance between the own ship PS and the other ship OP becomes equal to or less than the reference distance CD.

In other words, the distance-based collision risk value is 0 when the other ship OP is outside a circle CC (also called a circular bumper) with a radius of the reference distance CD centered on the own ship PS, and changes to 1 when the other ship OP enters inside the circle CC.

In the example shown in FIG. 8, the distance-based collision risk value is 0 when the other ship OP is outside a bumper BP set with reference to the own ship PS, and changes to 1 when the other ship OP enters inside the bumper BP. The bumper BP is defined by a reference distance that varies according to the heading with reference to the own ship PS.

The bumper BP is set so that the direction in which the own ship PS has an obligation to take evasive action when the other ship OP exists, that is, at least the range between the bow direction and the starboard direction of the own ship PS is larger than other ranges.

Returning to the illustration of FIG. 2, the alarm issuance determination unit 17 determines whether there is a collision risk between the own ship and the other ship based on the time-based collision risk value calculated by the time-based risk calculation unit 14 and the distance-based collision risk value calculated by the distance-based risk calculation unit 15.

In addition, the alarm issuance determination unit 17 determines whether an alarm to be issued according to whether there is a collision risk. That is, the alarm issuance determination unit 17 issues an alarm in a case where a collision risk exists, and does not issue an alarm in a case of no collision risk.

Specifically, the alarm issuance determination unit 17 determines that a collision risk exists in a case of receiving a value representing that a collision risk exists from any of the time-based risk calculation unit 14 and the distance-based risk calculation unit 15.

In other words, the alarm issuance determination unit 17 determines that a collision risk exists in a case where any of the time-based collision risk value and the distance-based collision risk value changes from a value representing no collision risk to a value representing that a collision risk exists.

In a case where alarm issuance becomes, the alarm issuance determination unit 17 drives the display controller 18 to display an image for alarm on the display unit 2. Additionally, the alarm issuance determination unit 17 may output a sound for alarm through a speaker (not shown), or may activate a warning light (not shown).

The parameter controller 16, in response to operation input of the user received by the operation input reception unit 13, adjusts either or both of the weight of the reference time for calculating the time-based collision risk value in the time-based risk calculation unit 14 and the weight of the reference distance for calculating the distance-based collision risk value in the distance-based risk calculation unit 15.

The weight of the reference time is a parameter for adjusting the reference time. The weight of the reference time can also be said to be a parameter that adjusts the sensitivity of the time-based collision risk value.

As the weight of the reference time increases, that is, as the reference time increases, the time indicator at which the time-based collision risk value changes to a value representing that a collision risk exists becomes larger (see FIG. 6). On the other hand, as the weight of the reference time decreases, that is, as the reference time decreases, the time indicator at which the time-based collision risk value changes to a value representing that a collision risk exists becomes smaller.

Similarly, the weight of the reference distance is a parameter for adjusting the reference distance. The weight of the reference distance can also be said to be a parameter that adjusts the sensitivity of the distance-based collision risk value.

As the weight of the reference distance increases, that is, as the reference distance increases, the distance indicator at which the distance-based collision risk value changes to a value representing that a collision risk exists becomes larger. On the other hand, as the weight of the reference distance decreases, that is, as the reference distance decreases, the distance indicator at which the distance-based collision risk value changes to a value representing that a collision risk exists becomes smaller.

The parameter controller 16 links the weight of the reference time and the weight of the reference distance. The linking of weights refers to a relationship that when one of the weight of the reference time and the weight of the reference distance changes, the other also changes accordingly.

Specifically, the parameter controller 16 decreases one of the weight of the reference time and the weight of the reference distance when increasing the other. That is, as the weight of the reference time becomes larger, the weight of the reference distance becomes smaller, and as the weight of the reference distance becomes larger, the weight of the reference time becomes smaller.

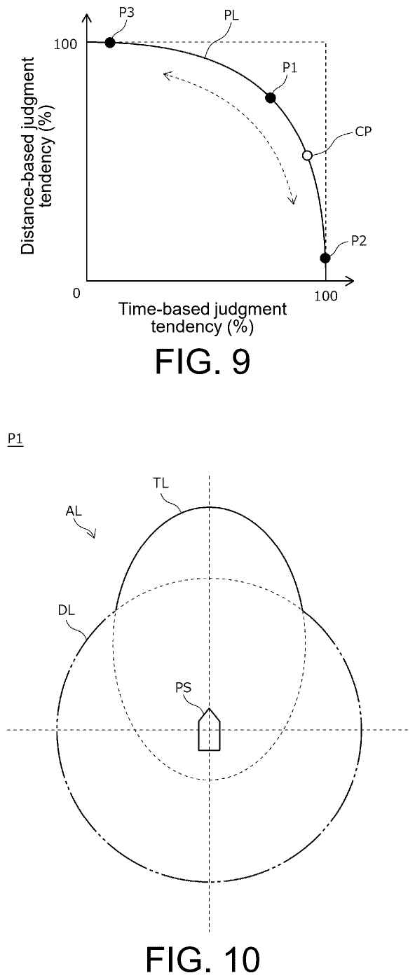

FIG. 9 is a diagram for illustrating an example of a judgment tendency graph for adjusting weights. The horizontal axis represents time-based judgment tendency, and the vertical axis represents distance-based judgment tendency. The time-based judgment tendency corresponds to the weight of the reference time, and the distance-based judgment tendency corresponds to the weight of the reference distance.

In the judgment tendency graph, a performance curve PL representing the relationship between the weight of the reference time and the weight of the reference distance is shown. The performance curve PL is defined so that as the weight of the reference time becomes larger, the weight of the reference distance becomes smaller, and as the weight of the reference distance becomes larger, the weight of the reference time becomes smaller.

On the performance curve PL, a control point CP is set for determining the weight of the reference time and the weight of the reference distance. The control point CP is defined to be movable along the performance curve PL. In other words, the control point CP can take any position on the performance curve PL.

The parameter controller 16 applies the weight of the reference time and the weight of the reference distance determined by the control point CP to the time-based risk calculation unit 14 and the distance-based risk calculation unit 15. Further, the parameter controller 16 moves the control point CP on the performance curve PL in response to the increase or decrease of an adjustment parameter specified from the operation input reception unit 13.

Point P1 is a point where both the weight of the reference time and the weight of the reference distance are moderate. FIG. 10 is a diagram showing an alarm line AL based on the own ship PS when the control point CP is at point P1.

The alarm line AL is a line where it is determined that a collision risk exists and an alarm is issued in a case where the other ship OP approaches. That is, the alarm line AL is a line where any of the time-based collision risk value and the distance-based collision risk value changes first from a value representing no collision risk to a value representing that a collision risk exists.

Specifically, the alarm line AL includes a time-based alarm line TL and a distance-based alarm line DL.

The time-based alarm line TL is a line where the time-based collision risk value changes from a value representing no collision risk to a value representing that a collision risk exists. The time-based alarm line TL corresponds to a first range. The time-based alarm line TL has, for example, an oval shape that extends in the bow direction of the own ship PS.

The distance-based alarm line DL is a line where any of the distance-based collision risk value changes from a value representing no collision risk to a value representing that a collision risk exists. The distance-based alarm line DL corresponds to a second range. The distance-based alarm line DL has, for example, a circular shape that extends equally and is centered on the own ship PS.

In each angular range centered on the own ship PS, the line on the far side from the own ship PS, among the time-based alarm line TL and the distance-based alarm line DL, becomes the alarm line AL.

The alarm line AL at point P1 is constructed by the time-based alarm line TL for the front portion including the bow direction with respect to the own ship PS, and the remaining portion is constructed by the distance-based alarm line DL. Therefore, the alarm line AL has a shape that is overall circular while having a front portion that protrudes in the bow direction.

By forming the alarm line AL that combines the time-based alarm line TL and the distance-based alarm line DL in this manner, it is possible to enjoy the benefits of both while complementing the disadvantages.

That is, with the time-based alarm line TL, while it is possible to secure a wide range in front of the own ship PS which is important for determining a collision risk, the range in the lateral and rear of the own ship PS becomes narrow. With the distance-based alarm line DL, while it is possible to secure a constant range around the own ship PS, the range in front of the own ship PS becomes narrow.

In contrast, by forming the alarm line AL that combines the time-based alarm line TL and the distance-based alarm line DL as in this example, it is possible to secure a wide range in front of the own ship PS and also secure a constant range in the lateral and rear of the own ship PS.

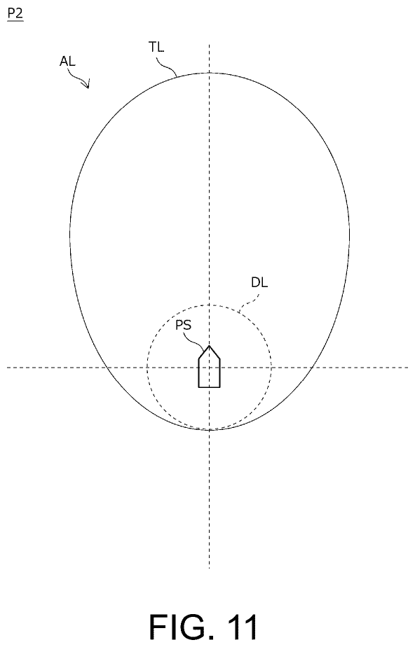

FIG. 11 is a diagram showing the alarm line based on the own ship PS when the control point CP is at point P2. Point P2 is a point where the weight of the reference time is in the vicinity of maximum value while the weight of the reference distance is in the vicinity of minimum value (see FIG. 9).

At point P2, the time-based alarm line TL becomes sufficiently larger compared to the distance-based alarm line DL. Therefore, the alarm line AL is mainly constructed by the time-based alarm line TL, resulting in, for example, an oval shape that extends in the bow direction of the own ship PS.

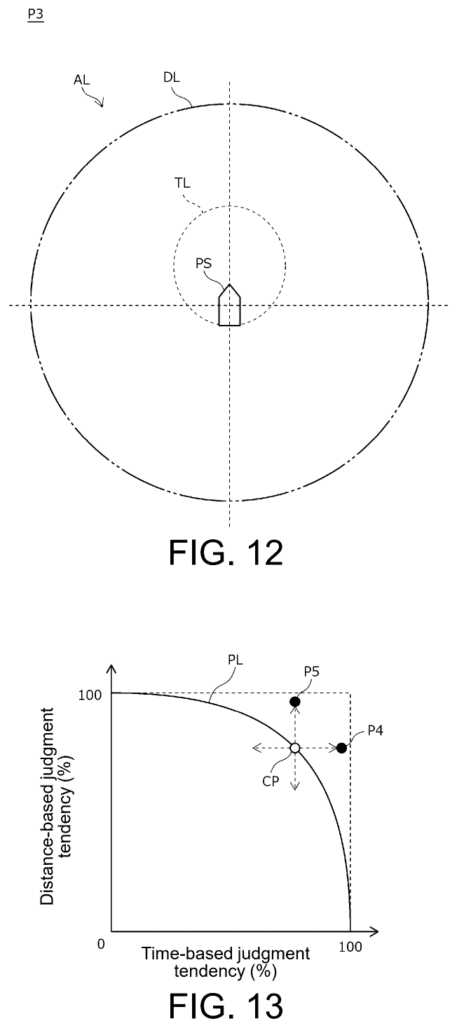

FIG. 12 is a diagram showing the alarm line based on the own ship PS when the control point CP is at point P3. Point P3 is a point where the weight of the reference distance is in the vicinity of maximum value while the weight of the reference time is in the vicinity of minimum value (see FIG. 9).

At point P3, the distance-based alarm line DL becomes sufficiently larger compared to the time-based alarm line TL. Therefore, the alarm line AL is mainly constructed by the distance-based alarm line DL, resulting in, for example, a circular shape that extends equally and is centered on the own ship PS.

As described above, by making it possible to adjust the weight of the reference time and the weight of the reference distance in response to operation input of the user, it is possible to provide collision risk determination that matches the sense of each navigator.

In the above example, the movement range of the control point CP in the judgment tendency graph shown in FIG. 9 is limited to the performance curve PL, but the disclosure is not limited thereto, and as shown in FIG. 13, the control point CP may also be movable to a position off the performance curve PL.

Point P4 is a point where the weight of the reference time is increased while maintaining the weight of the reference distance from the position of the control point CP. That is, point P4 is a point where the weight of the reference time is in the vicinity of maximum value, and the weight of the reference distance is moderate.

Moving the control point CP in the horizontal direction, that is, moving in parallel to the first axis, means adjusting only the weight of the reference time among the weight of the reference time and the weight of the reference distance.

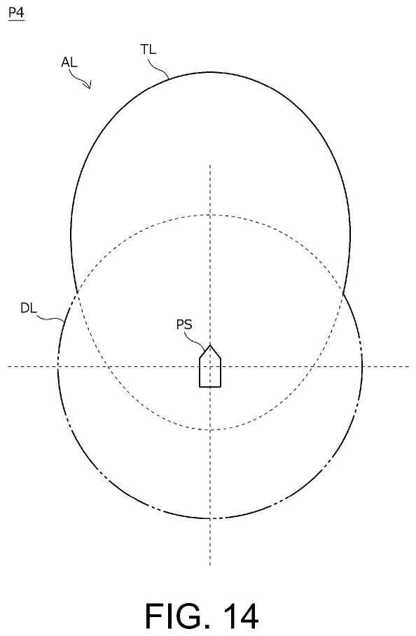

As shown in FIG. 14, at Point P4, the time-based alarm line TL becomes maximally large, and the distance-based alarm line DL becomes moderate. Therefore, the alarm line AL has, for example, a shape in which an oval shape of approximately the same width is superimposed on the front part of a circular shape surrounding the own ship PS.

Point P5 is a point where the weight of the reference distance is increased while maintaining the weight of the reference time from the position of the control point CP. That is, point P5 is a point where the weight of the reference time is moderate, and the weight of the reference distance is in the vicinity of maximum value.

Moving the control point CP in the vertical direction, that is, moving in parallel to the second axis, means adjusting only the weight of the reference distance among the weight of the reference time and the weight of the reference distance.

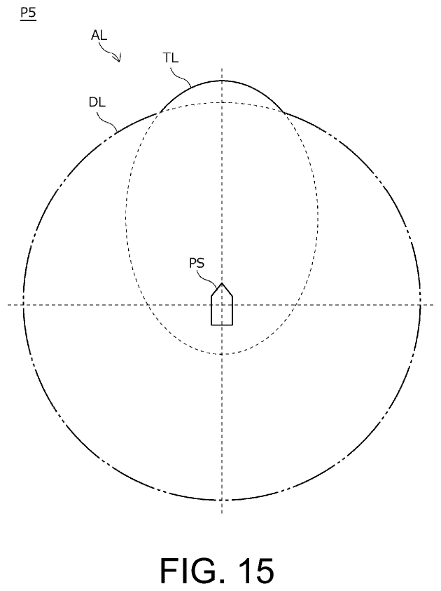

As shown in FIG. 15, at point P5, the time-based alarm line TL becomes moderate, and the distance-based alarm line DL becomes maximally large. Therefore, the alarm line AL has, for example, a shape which is a large circular shape and in which the front portion slightly protrudes in the bow direction.

As described above, by making it possible to move the control point CP to a position off the performance curve PL, it is possible to further improve the flexibility in adjusting the weight of the reference time and the weight of the reference distance.

Returning to the illustration of FIG. 2, the display controller 18 displays an image representing the positional relationship between the own ship and the other ship on the display unit 2, based on the own ship data acquired by the own ship data acquisition unit 11 and the other ship data acquired by the other ship data acquisition unit 12.

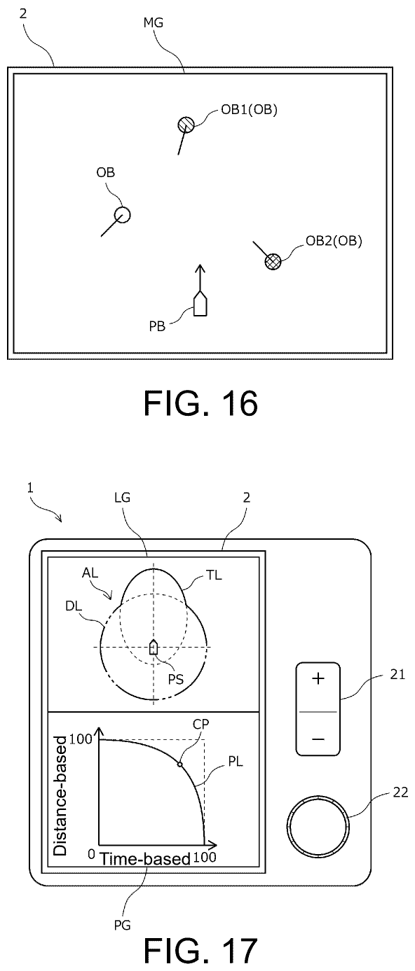

Specifically, as shown in FIG. 16, the display controller 18 displays an image MG including a symbol PB representing the own ship and a symbol OB representing another ship on the display unit 2. The image MG is, for example, a radar image, an electronic chart, or a composite image of these.

The symbol PB representing the own ship is placed at a position in the image corresponding to the actual position of the own ship. The symbol OB representing another ship is also placed at a position in the image corresponding to the actual position of the other ship. The symbol PB representing the own ship may be omitted.

In addition, the display controller 18 emphasizes the display of symbols OB1 and OB2 representing other ships that have been determined to have a collision risk by the alarm issuance determination unit 17.

At this time, the display controller 18 displays with distinction between the symbol OBI representing another ship that has been determined to have a collision risk based on the time-based collision risk value calculated by the time-based risk calculation unit 14, and the symbol OB2 representing another ship that has been determined to have a collision risk based on the distance-based collision risk value calculated by the distance-based risk calculation unit 15.

The display with distinction is realized, for example, by making the colors, patterns, shapes, sizes, etc. of the symbols OB1 and OB2 representing other ships different from each other. This enables the user to visually grasp whether the existence of a collision risk has been determined based on the time-based collision risk value or the distance-based collision risk value.

Furthermore, the display controller 18 may display an alarm line image LG and a judgment tendency image PG on the display unit 2 as shown in FIG. 17. The alarm line image LG is an image showing the alarm line AL mentioned above (see FIG. 10 to FIG. 12 and FIG. 14 to FIG. 15). The judgment tendency image PG is an image showing the judgment tendency graph mentioned above (see FIG. 9 and FIG. 13).

The navigation assistance device 1 may be provided with, for example, the button 21 or the rotary knob 22 that allows operation input in two directions, and the parameter controller 16 may adjust the weight of the reference time and the weight of the reference distance in response to the operation input from the button 21 or the rotary knob 22.

The operation input in two directions using the button 21 is, for example, made in the upward direction and downward direction or +direction and −direction, etc. The operation input using the rotary knob 22 is made in the clockwise direction and counterclockwise direction.

The parameter controller 16 increases the weight of the reference time in response to the operation input in the first direction from the button 21 or the rotary knob 22, and increases the weight of the reference distance in response to the operation input in the second direction.

Specifically, with the operation input in the first direction, the parameter controller 16 moves the control point CP in the judgment tendency graph (see FIG. 9 and FIG. 13) along the performance curve PL in the direction (lower right direction in the figure) in which the weight of the reference time increases and the weight of the reference distance decreases.

On the other hand, with the operation input in the second direction, the parameter controller 16 moves the control point CP in the judgment tendency graph along the performance curve PL in the direction (upper left direction in the figure) in which the weight of the reference distance increases and the weight of the reference time decreases.

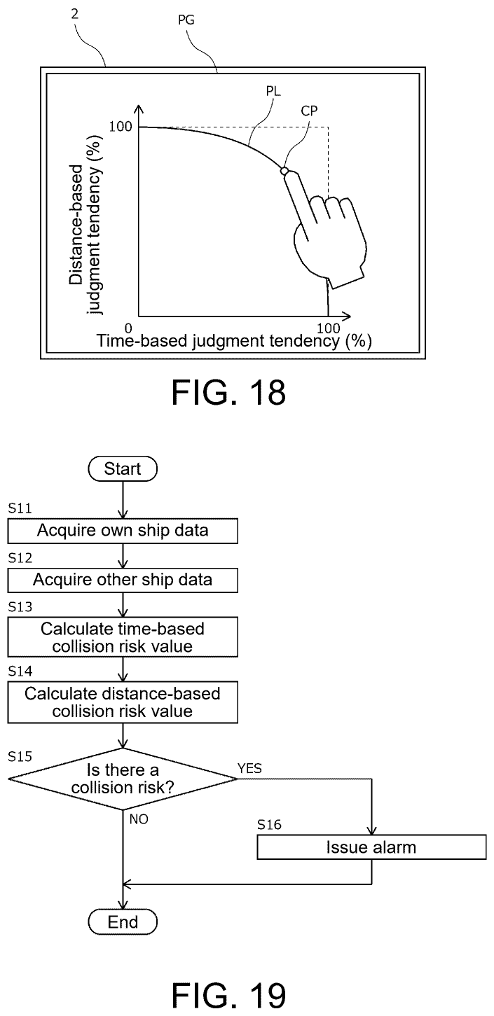

Additionally, the parameter controller 16 may change the position of the control point CP according to the position within the judgment tendency graph specified by the user in the judgment tendency image PG displayed on the display unit 2, as shown in FIG. 18.

When the control point CP is moved by the operation input from the button 21 or the rotary knob 22, or by the specification of a position on the screen, the display controller 18 accordingly updates the position of the control point CP in the judgment tendency image PG displayed on the display unit 2, and further updates the shape of the alarm line AL in the alarm line image LG.

As described above, by displaying the alarm line image LG and the judgment tendency image PG on the display unit 2, and further updating the display in accordance with the parameter changes, the user can visually grasp the assessment criteria for a collision risk.

FIG. 19 is a flowchart mainly showing an example of the procedure for processing related to determination of a collision risk, in the navigation assistance method implemented in the navigation assistance device 1. The processing circuitry 20 of the navigation assistance device 1 periodically executes the information processing shown in the figure according to a program.

First, the processing circuitry 20 acquires own ship data representing the position and speed of the own ship from the GNSS receiver 6, etc. (S11, processing as the own ship data acquisition unit 11).

Next, the processing circuitry 20 acquires other ship data representing the position and speed of the other ship from the radar 3, the AIS 4, or the camera 5 (S12, processing as the other ship data acquisition unit 12).

Next, the processing circuitry 20 calculates a time-based collision risk value based on the own ship data acquired in S11 and the other ship data acquired in S12 (S13, processing as the time-based risk calculation unit 14).

Similarly, the processing circuitry 20 calculates a distance-based collision risk value based on the own ship data acquired in S11 and the other ship data acquired in S12 (S14, processing as the distance-based risk calculation unit 15).

Next, the processing circuitry 20 determines whether a collision risk exists or not based on the time-based collision risk value calculated in S13 and the distance-based collision risk value calculated in S14 (S15, processing as the alarm issuance determination unit 17).

In a case where it is determined that a collision risk exists (S15: YES), the processing circuitry 20 issues an alarm (S16, processing as the alarm issuance determination unit 17).

On the other hand, in a case where it is determined as no collision risk (S15: NO), the processing circuitry 20 ends the processing as it is.

Although the embodiments of the disclosure have been described above, the disclosure is not limited to the embodiments described above, and various modifications are of course possible for those skilled in the art.

The following lists representative embodiments of the disclosure.
(1) A navigation assistance device, including:
   processing circuitry configured to:
   acquire first ship data representing a position and a speed of a first ship;
   acquire second ship data representing a position and a speed of a second ship;
   calculate a first collision risk value based on a time when the second ship approaches the first ship, based on the first ship data and the second ship data;
   calculate a second collision risk value based on a distance between the first ship and the second ship, based on the first ship data and the second ship data; and
   determine whether a collision risk exists between the first ship and the second ship based on the first collision risk value and the second collision risk value.
(2) The navigation assistance device according to (1), in which the processing circuitry is further configured to adjust one or both of a weight of a reference time when the first collision risk value changes from a value representing no collision risk to a value representing that a collision risk exists, and a weight of a reference distance at which the second collision risk value changes from a value representing no collision risk to a value representing that a collision risk exists.
(3) The navigation assistance device according to (2), in which the processing circuitry is further configured to link the weight of the reference time and the weight of the reference distance.
(4) The navigation assistance device according to (2) or (3), in which the processing circuitry is further configured to decrease one of the weight of the reference time and the weight of the reference distance when increasing the other.

(5) The navigation assistance device according to any one of (1) to (4), in which the processing circuitry is further configured to display an image showing a first range where the first collision risk value becomes a value representing that a collision risk exists, and a second range where the second collision risk value becomes a value representing that a collision risk exists, based on the first ship.
(6) The navigation assistance device according to any one of (2) to (5), in which the processing circuitry is further configured to receive operation input in a first direction from a user and operation input in a second direction opposite to the first direction,
   in which the processing circuitry is further configured to increase the weight of the reference time in response to operation input in the first direction, and increase the weight of the reference distance in response to operation input in the second direction.
(7) The navigation assistance device according to any one of (2) to (6), in which the processing circuitry is further configured to:
   display a graph having a first axis corresponding to the weight of the reference time and a second axis corresponding to the weight of the reference distance; and
   receive operation input from a user specifying a position within the graph,
   in which the processing circuitry is further configured to adjust one or both of the weight of the reference time and the weight of the reference distance according to the position within the graph specified by the user.
(8) The navigation assistance device according to any one of (1) to (7), in which the processing circuitry is further configured to display an image representing a positional relationship between the first ship and the second ship based on the first ship data and the second ship data,
in which the processing circuitry is further configured to display with distinction, in the image, a symbol representing the second ship determined to have a collision risk based on the first collision risk value and a symbol representing the second ship determined to have a collision risk based on the second collision risk value.
(9) The navigation assistance device according to any one of (1) to (8), in which the processing circuitry is further configured to determine to issue an alarm according to whether a collision risk exists.
(10) A navigation assistance method, including:
   acquiring first ship data representing a position and a speed of a first ship;
   acquiring second ship data representing a position and a speed of a second ship;
   calculating a first collision risk value based on a time when the second ship approaches the first ship, based on the first ship data and the second ship data;
   calculating a second collision risk value based on a distance between the first ship and the second ship, based on the first ship data and the second ship data; and
   determining whether a collision risk exists between the first ship and the second ship based on the first collision risk value and the second collision risk value.
(11) A non-transient computer-readable recording medium recording a program for causing a computer to execute:
   acquiring first ship data representing a position and a speed of a first ship;
   acquiring second ship data representing a position and a speed of a second ship;
   calculating a first collision risk value based on a time when the second ship approaches the first ship, based on the first ship data and the second ship data;
   calculating a second collision risk value based on a distance between the first ship and the second ship, based on the first ship data and the second ship data; and
   determining whether a collision risk exists between the first ship and the second ship based on the first collision risk value and the second collision risk value.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A navigation assistance device, comprising:
processing circuitry configured to:
acquire first ship data representing a position and a speed of a first ship;
acquire second ship data representing a position and a speed of a second ship;
calculate a first collision risk value based on a time when the second ship approaches the first ship, based on the first ship data and the second ship data;
calculate a second collision risk value based on a distance between the first ship and the second ship, based on the first ship data and the second ship data; and
determine whether a collision risk exists between the first ship and the second ship based on the first collision risk value and the second collision risk value.

2. The navigation assistance device according to claim 1, wherein the processing circuitry is further configured to adjust one or both of a weight of a reference time when the first collision risk value changes from a value representing no collision risk to a value representing that a collision risk exists, and a weight of a reference distance at which the second collision risk value changes from a value representing no collision risk to a value representing that a collision risk exists.

3. The navigation assistance device according to claim 2, wherein the processing circuitry is further configured to link the weight of the reference time and the weight of the reference distance.

4. The navigation assistance device according to claim 2, wherein the processing circuitry is further configured to decrease one of the weight of the reference time and the weight of the reference distance when increasing the other.

5. The navigation assistance device according to claim 1, wherein the processing circuitry is further configured to display an image showing a first range where the first collision risk value becomes a value representing that a collision risk exists, and a second range where the second collision risk value becomes a value representing that a collision risk exists, based on the first ship.

6. The navigation assistance device according to claim 2, wherein the processing circuitry is further configured to display an image showing a first range where the first collision risk value becomes a value representing that a collision risk exists, and a second range where the second collision risk value becomes a value representing that a collision risk exists, based on the first ship.

7. The navigation assistance device according to claim 2, wherein the processing circuitry is further configured to receive operation input in a first direction from a user and operation input in a second direction opposite to the first direction,
wherein the processing circuitry is further configured to increase the weight of the reference time in response to operation input in the first direction, and increase the weight of the reference distance in response to operation input in the second direction.

8. The navigation assistance device according to claim 2, wherein the processing circuitry is further configured to:
display a graph having a first axis corresponding to the weight of the reference time and a second axis corresponding to the weight of the reference distance; and
receive operation input from a user specifying a position within the graph,
wherein the processing circuitry is further configured to adjust one or both of the weight of the reference time and the weight of the reference distance according to the position within the graph specified by the user.

9. The navigation assistance device according to claim 1, wherein the processing circuitry is further configured to display an image representing a positional relationship between the first ship and the second ship based on the first ship data and the second ship data,
wherein the processing circuitry is further configured to display with distinction, in the image, a symbol representing the second ship determined to have a collision risk based on the first collision risk value and a symbol representing the second ship determined to have a collision risk based on the second collision risk value.

10. The navigation assistance device according to claim 2, wherein the processing circuitry is further configured to display an image representing a positional relationship between the first ship and the second ship based on the first ship data and the second ship data,
wherein the processing circuitry is further configured to display with distinction, in the image, a symbol representing the second ship determined to have a collision risk based on the first collision risk value and a symbol representing the second ship determined to have a collision risk based on the second collision risk value.

11. The navigation assistance device according to claim 3, wherein the processing circuitry is further configured to display an image representing a positional relationship between the first ship and the second ship based on the first ship data and the second ship data,
wherein the processing circuitry is further configured to display with distinction, in the image, a symbol representing the second ship determined to have a collision risk based on the first collision risk value and a symbol representing the second ship determined to have a collision risk based on the second collision risk value.

12. The navigation assistance device according to claim 5, wherein the processing circuitry is further configured to display an image representing a positional relationship between the first ship and the second ship based on the first ship data and the second ship data,
wherein the processing circuitry is further configured to display with distinction, in the image, a symbol representing the second ship determined to have a collision risk based on the first collision risk value and a symbol representing the second ship determined to have a collision risk based on the second collision risk value.

13. The navigation assistance device according to claim 6, wherein the processing circuitry is further configured to display an image representing a positional relationship between the first ship and the second ship based on the first ship data and the second ship data,
wherein the processing circuitry is further configured to display with distinction, in the image, a symbol representing the second ship determined to have a collision risk based on the first collision risk value and a symbol representing the second ship determined to have a collision risk based on the second collision risk value.

14. The navigation assistance device according to claim 7, wherein the processing circuitry is further configured to display an image representing a positional relationship between the first ship and the second ship based on the first ship data and the second ship data,
wherein the processing circuitry is further configured to display with distinction, in the image, a symbol representing the second ship determined to have a collision risk based on the first collision risk value and a symbol representing the second ship determined to have a collision risk based on the second collision risk value.

15. The navigation assistance device according to claim 1, wherein the processing circuitry is further configured to determine to issue an alarm according to whether a collision risk exists.

16. The navigation assistance device according to claim 2, wherein the processing circuitry is further configured to determine to issue an alarm according to whether a collision risk exists.

17. The navigation assistance device according to claim 3, wherein the processing circuitry is further configured to determine to issue an alarm according to whether a collision risk exists.

18. The navigation assistance device according to claim 5, wherein the processing circuitry is further configured to determine to issue an alarm according to whether a collision risk exists.

19. A navigation assistance method, comprising:
acquiring first ship data representing a position and a speed of a first ship;
acquiring second ship data representing a position and a speed of a second ship;
calculating a first collision risk value based on a time when the second ship approaches the first ship, based on the first ship data and the second ship data;
calculating a second collision risk value based on a distance between the first ship and the second ship, based on the first ship data and the second ship data; and
determining whether a collision risk exists between the first ship and the second ship based on the first collision risk value and the second collision risk value.

20. A non-transient computer-readable recording medium recording a program for causing a computer to execute:
acquiring first ship data representing a position and a speed of a first ship;
acquiring second ship data representing a position and a speed of a second ship;
calculating a first collision risk value based on a time when the second ship approaches the first ship, based on the first ship data and the second ship data;
calculating a second collision risk value based on a distance between the first ship and the second ship, based on the first ship data and the second ship data; and
determining whether a collision risk exists between the first ship and the second ship based on the first collision risk value and the second collision risk value.
